(19) United States
(12) Patent Application Publication
(10) Pub. No.: US 2024/0351281 A1
(43) Pub. Date: Oct. 24, 2024

(54) HEATED EXTRUDER FOR 3D CONCRETE PRINTER

(71) Applicant: CEM TECH LLC, Solana Beach, CA (US)

(72) Inventors: Pierre Viaud-Murat, Bloomfield Hills, MI (US); Frank Marquette, Troy, AL (US); Steve Santa Cruz, La Jolla, CA (US); Michael Taylor, Carlsbad, CA (US); Jason Martin, San Diego, CA (US)

(21) Appl. No.: 18/640,894

(22) Filed: Apr. 19, 2024

Related U.S. Application Data
(60) Provisional application No. 63/496,971, filed on Apr. 19, 2023.

(51) Int. Cl. B29C 64/209; B29C 64/295; B29C 64/314; B33Y 30/00; B33Y 70/00

(52) U.S. Cl. CPC B29C 64/209; B29C 64/295; B29C 64/314; B33Y 30/00; B33Y 70/00

(57) ABSTRACT

A heated extruder for 3D printing of a cementitious material can include a mixing and deposition nozzle including a hopper in communication with a mixing tube, where the mixing tube can be in communication with a deposition tip. A heating element can be disposed on an outside surface of the mixing tube and configured to transfer heat to an interior portion of the mixing tube. An auger including a flight having a perforation can be disposed within the mixing tube. The auger can be configured to promote mixing and pumping of the cementitious material through the mixing tube to provide a homogeneous distribution of heat throughout the cementitious material when the heating element transfers heat to the interior portion of the mixing tube.

### FIELD

The present technology includes articles of manufacture and processes that relate to 3D printing, including 3D concrete printing and a heated extruder for 3D concrete printing.

### INTRODUCTION

This section provides background information related to the present disclosure which is not necessarily prior art.

3D concrete printing is a technology that involves using additive manufacturing techniques to produce concrete structures layer by layer. This technology provides a fast, efficient, and cost-effective method for producing complex concrete structures with high precision and accuracy. Traditional concrete construction methods typically involve the use of precast or cast-in-place concrete, which may be time-consuming and labor-intensive. With 3D printing, however, the construction process may be automated, reducing the need for manual labor and enabling faster construction times. Additionally, the ability to produce complex shapes and designs allows for greater design flexibility and may lead to more aesthetically pleasing structures.

Researchers and engineers continue to work on improving 3D concrete printing technology, experimenting with different materials and techniques to enhance the durability, strength, and sustainability of 3D printed concrete and other cementitious material structures. Often, when 3D concrete printing, it may be desirable to accelerate the chemical reaction rate of cementitious materials as they solidify. Currently, the chemical reaction process may be accelerated using steam and/or chemical additives. However, while such processes may speed up hardening, they may not be cost effective, practical, and/or may compromise the mechanical properties of the finished cementitious material.

Cementitious materials can include Portland Cement, Calcium Sulfoaluminate Cement, Geopolymer Cement, and others, without compromising the mechanical properties of the finished cementitious material.

### SUMMARY

In concordance with the instant disclosure, a cost-effective system and method that can accelerate the chemical reaction process leading to the hardening of a cementitious material without compromising its long term mechanical properties is described.

Various embodiments of the present disclosure relate to a heated extruder for 3D concrete printing. The heated extruder can use heat to accelerate the chemical reaction process for a cementitious mixture. In particular, the heated extruder may accelerate the initial set of cementitious materials making these materials more favorable for 3D concrete printing.

The heated extruder can include a mixing and deposition nozzle including a hopper in communication with a mixing tube and the mixing tube in communication with a deposition tip. A heating element can be disposed on an outside surface of the mixing tube. The heating element can be configured to transfer heat to an interior portion of the mixing tube. The heated extruder can further include an auger. The auger can include a flight having a perforation. The auger can be configured to promote mixing and pumping of the cementitious material through the mixing tube to affect a homogeneous distribution of heat throughout the cementitious material when the heating element transfers heat to the interior portion of the mixing tube.

In certain embodiments, the heated extruder for 3D printing cementitious materials can further include a sensor configured to measure the temperature of the cementitious material. The cementitious material sensor can include an external sensor configured to measure a temperature of the cementitious material during deposition. For example, the cementitious material sensor can include a thermal camera. In certain embodiments, the cementitious material sensor can be located along a length of the mixing and deposition nozzle.

The heating element can include a plurality of external band heaters. The heating element can be disposed around an entirety of the outside surface of the mixing tube. In certain embodiments, a temperature of the heating element can be measured by a thermocouple. The temperature of the heating element can be regulated by an external controller.

The external controller can include a proportional, integral, derivative (PID) controller. In certain embodiments, the heating element can be configured to heat the cementitious material to a temperature from 50° F. to 150° F. The heated extruder for 3D printing of cementitious materials can further include a motor for driving the auger, and a control device for controlling the heated extruder. In certain embodiments, the auger flight includes a plurality of perforations. A portion of the auger can be disposed within the hopper.

An extrusion method for 3D printing a cementitious material can include providing a mixing and deposition nozzle. The mixing and deposition nozzle can include a hopper in communication with a mixing tube, where the mixing tube is in communication with a deposition tip. A heating element can be disposed on an outside surface of the mixing tube of the mixing and deposition nozzle. The heating element can be configured to transfer heat to an interior portion of the mixing tube. An auger disposed within the mixing tube of the deposition nozzle can include a flight having a perforation. The auger can be configured to promote mixing and pumping of the cementitious material through the mixing tube and provide a homogeneous distribution of heat throughout the cementitious material when the heating element transfers heat to the interior portion of the mixing tube. The cementitious material can be conveyed from the hopper to the mixing tube. The cementitious material can be heated to a predetermined temperature to accelerate the chemical reaction process of the cementitious material using the heating element at the mixing tube. The auger can be configured to promote mixing and pumping of the cementitious material through the mixing tube to affect a homogeneous distribution of heat throughout the cementitious material when the heating element transfers heat to the interior portion of the mixing tube. In certain embodiments, a portion of the auger can be disposed within the hopper. Conveying the cementitious material from the hopper to the mixing tube can be performed by the auger.

In certain embodiments, the material conveying and heating functions can be split between multiple modules consisting in a remote pumping device placed upstream, and a passive or active mixing device fitted with heating elements connected with the nozzle. The auger and the hopper can be replaced with a pump conveying the cementitious material to a heated passive or active mixing device connected with the nozzle.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram showing a heated extruder for 3D printing of a cementitious material, according to an embodiment of the present disclosure.

FIG. 2A is a drawing showing a side elevation view of a heated extruder for 3D printing of a cementitious material, according to an embodiment of the present disclosure.

FIG. 2B is a drawing showing a side elevation cutaway view of the heated extruder for 3D printing of a cementitious material, according to an embodiment of the present disclosure;

FIG. 3A is a drawing showing a side elevation view of a portion of an auger for a heated extruder for 3D printing of a cementitious material, according to an embodiment of the present disclosure.

FIG. 3B is a drawing showing a top plan view of a portion of an auger for a heated extruder for 3D printing of a cementitious material, according to an embodiment of the present disclosure.

FIG. 3C is a drawing showing a perspective view of a portion of an auger for a heated extruder for 3D printing of a cementitious material, according to an embodiment of the present disclosure.

FIG. 4 is a flowchart showing an extrusion method for 3D printing a cementitious material, according to an embodiment of the present disclosure.

FIG. 5A is a drawing showing a side elevation view of a split module configuration of a heated extruder for 3D printing of a cementitious material, with a remote concrete pump hose supplying printing material, and a passive mixing device fitted with heating elements connected with the nozzle, according to an embodiment of the present disclosure.

FIG. 5B is a drawing showing a side elevation view of a split module configuration of a heated extruder for 3D printing of a cementitious material, with a remote concrete pump hose supplying printing material, and an active mixing head fitted with heating elements connected with the nozzle, according to an embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology relates to a heated extruder and process for concrete or cementitious material 3D printing. Heat applied to cementitious materials can accelerate the chemical reaction in which the material solidifies.

The heated extruder can use an external heating element disposed along an outside surface of a mixing tube of the heated extruder to affect a chemical reaction process of the material by heating the material just enough to accelerate the hardening process. The external heating element can include band heaters and thermocouples along an outside surface of a barrel or the material mixing tube of the heated extruder. In particular, the heating element can include any appropriately desired heating element and/or combination of heating elements for accelerating the chemical reaction process of the cementitious material. The external heating element can transfer heat to the interior of the material mixing tube, such that the material within the heated extruder is heated to a predetermined temperature at which the chemical reaction process can begin. A temperature of the material can be monitored at various points, including after the material is extruded, as the material is extruded at a nozzle tip, and/or at other locations of the heated extruder.

The external heating element can be controlled by a PID controller and can be configured to deliver and maintain heat regulation for appropriate chemical reaction regulation as monitored by a sensor of the heated extruder. An auger can include a flight having a perforation passing through the flight to promote a mixing of heated material from the mixing chamber walls into a body of the mix while pumping to affect a homogenous distribution of heat throughout the material extrusion. The heating element disposed on the outside surface of the mixing tube of the heated extruder in combination with the auger can affect a mixing of material exposed to the heating element with material not exposed to the heating element. This can ensure a uniformly heated, homogeneous material as the material is extruded at the nozzle tip.

Advantageously, the heated extruder can use heat to accelerate the chemical reaction hardening process for a cementitious mixture. In particular, the heated extruder can accelerate the initial set of the cementitious material making the material more favorable for 3D concrete printing. The heated extruder can regulate a temperature to accelerate a chemical reaction process during a deposition of material with lesser or even no use of chemicals. In particular, the heated extruder can influence the temperature of the extruded material to accelerate the hardening process as appropriately desired. Effective mixing by the auger, in addition to the pumping function, provides a homogeneous thermal profile for the cementitious mixture, optimizing the consistency of the hardening process of cementitious mixture for deposition by 3D printing. Accordingly, the heated extruder as described herein has many advantages.

Example embodiments of the present technology are provided with reference to the figures enclosed herewith.

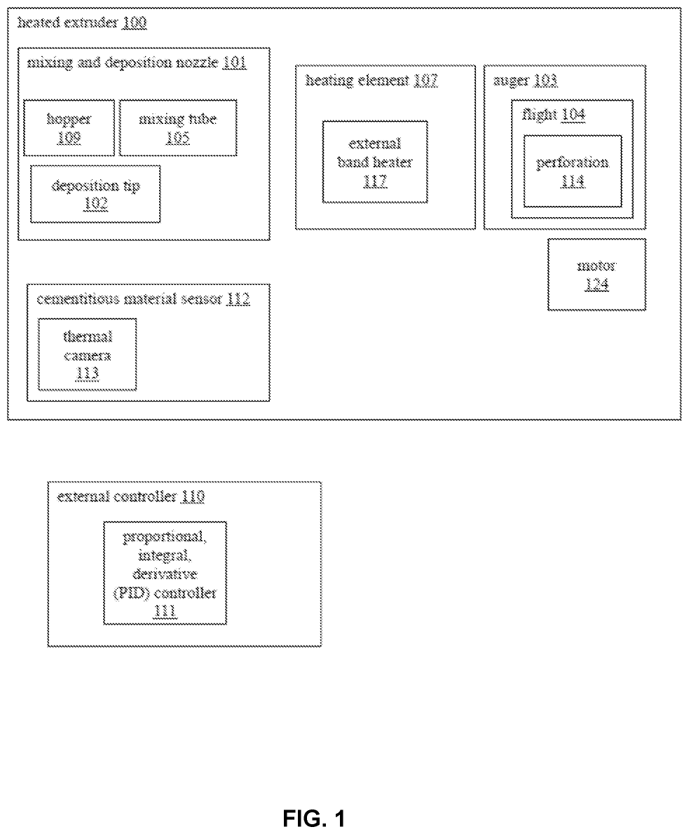

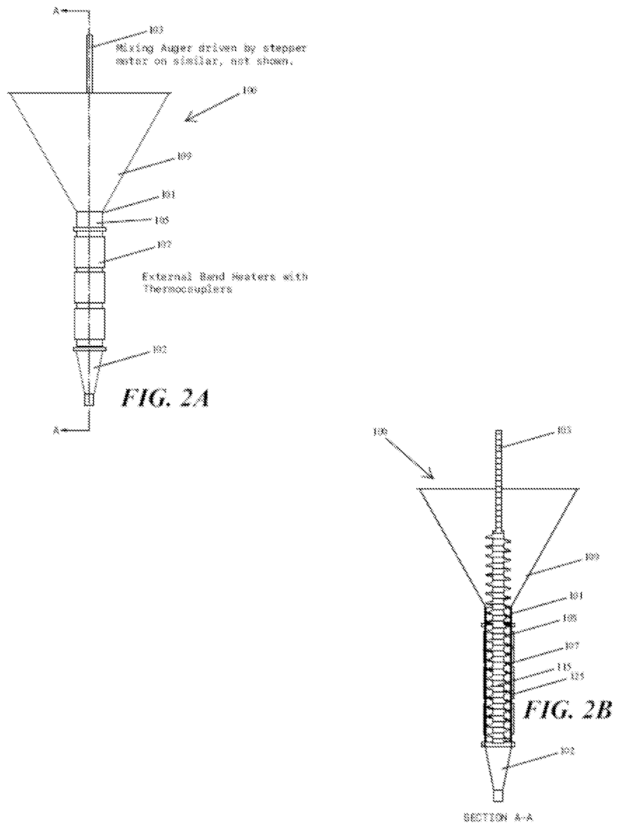

FIG. 1 is a block diagram showing a heated extruder 100 for 3D printing of a cementitious material. The heated extruder 100 for 3D printing of a cementitious material can include a mixing and deposition nozzle 101 and an auger 103, some examples of which are described in more detail below. The heated extruder 100 can also include a heating element 107 disposed on an outside surface 125, e.g., as illustrated in FIG. 2B, of a mixing tube 105 of the mixing and deposition nozzle 101. The heating element 107 can be configured to transfer heat to an interior portion 115 (FIG. 2B) of the mixing tube 105. The mixing and deposition nozzle 101 can also include a hopper 109 in communication with the mixing tube 105. The mixing tube 105 can be in communication with a deposition tip 102.

The auger 103 can include a flight 104. The flight 104 can also include a perforation 114, as described in more detail below. The auger 103 can be disposed within the mixing tube 105. The auger 103 can be configured to promote mixing and pumping of the cementitious material through the mixing tube 105 in order to provide a homogeneous distribution of heat throughout the cementitious material when the heating element 107 transfers heat to an interior portion 115 of the mixing tube 105. A motor 124 can be configured to drive the auger 103. In still certain embodiments, a portion of the auger 103 can be disposed within the hopper 109.

The heating element 107 can be disposed around an entirety of the outside surface of the mixing tube 105. However, the heating element 107 can be placed at any appropriately desired location and/or various locations of the mixing nozzle 101, ad in particular mixing tube 105. In certain embodiments, a temperature of the heating element 107 can be measured by a thermocouple. In particular embodiments, a temperature of the heating element 107 can be regulated by an external controller 110. The heating element 107 can include one or more external band heaters 117. However, as would be apparent to someone of ordinary skill in the art, the heating element 107 can include any number, configuration, and/or design of heating devices for transferring heat to the mixing tube 105.

The external controller 110 can include a PID controller 111. However, the external controller 110 can include any appropriately desired controller for controlling the heating element. In certain embodiments, the heating element 107 can be configured to heat the cementitious material to a temperature from 50° F. to 150° F.

The heated extruder 100 for 3D printing of a cementitious material can include various sensors. For example, a cementitious material sensor 112 can be configured to measure a temperature of the cementitious material after deposition. In some embodiments, the cementitious material sensor 112 can include a thermal camera 113. In particular, the heated extruder 100 for 3D printing of a cementitious material can include various sensors for monitoring a temperature of the cementitious material at various points, including after the material is extruded, as the material is extruded at a nozzle tip 102, and/or at other locations of the heated extruder 100. In certain embodiments, the cementitious material sensor 112 can be located along a length of the mixing and deposition nozzle 101.

FIGS. 2A and 2B show an example heated extruder 100 for 3D printing of a cementitious material, such as described above. The heated extruder 100 for 3D printing of a cementitious material can include a mixing and deposition nozzle 101 and an auger 103. The heated extruder 100 can also include a heating element 107 disposed on an outside surface 125 of, e.g., a mixing tube 105 of the mixing and deposition nozzle 101. The heating element 107 can be configured to transfer heat to an interior portion 115 of the mixing tube 105. The mixing and deposition nozzle 101 can also include a hopper 109 in communication with the mixing tube 105. The mixing tube 105 can be in communication with a deposition tip 102.

The heating element 107 can be disposed around an entirety of the outside surface of the mixing tube 105. However, the heating element 107 can be placed at any appropriately desired location and/or various locations of the mixing tube 105. In certain embodiments, a temperature of the heating element 107 can be measured by a thermocouple. In particular embodiments, a temperature of the heating element 107 can be regulated by an external controller 110, such as a PID controller as described. The heating element 107 can include one or more external band heaters 117. However, as would be apparent to someone of ordinary skill in the art, the heating element 107 can include any number, configuration, and/or design of heating devices for transferring heat to the mixing tube 105.

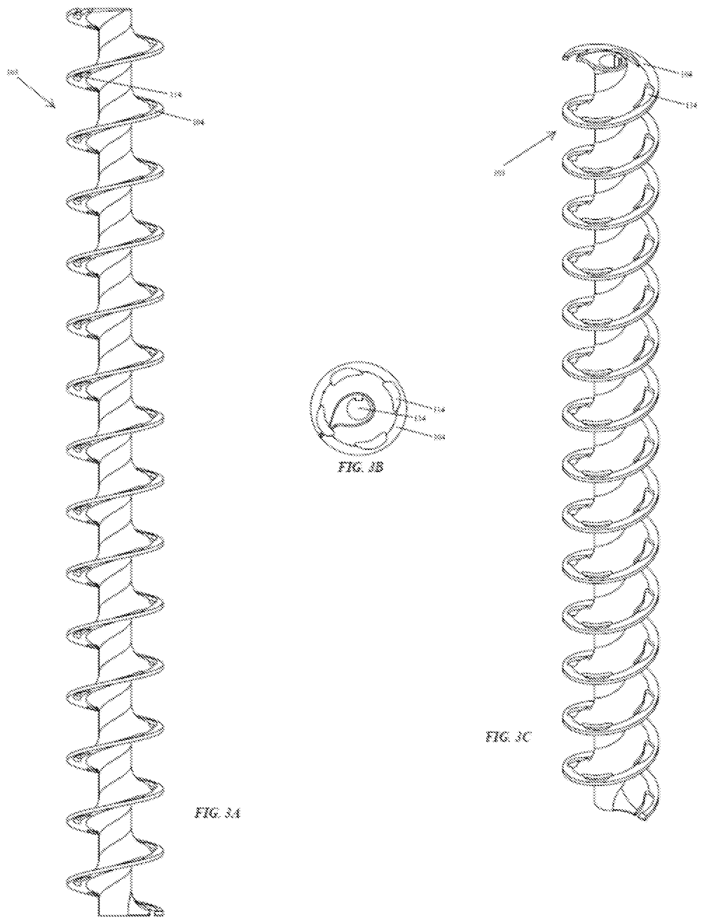

As shown in FIGS. 3A-3C, the auger 103 can include a flight 104 and a through hole 134 for connecting the auger 103. The flight 104 can also include a perforation 114. The auger 103 can be disposed within the mixing tube 105. The auger 103 can be configured to promote mixing and pumping of the cementitious material through the mixing tube 105 in order to provide a homogeneous distribution of heat throughout the cementitious material when the heating element 107 transfers heat to an interior portion 115 of the mixing tube 105. In particular, the perforations 114 running through the flights 104 can promote a mixing of heated cementitious material from the chamber walls into the body of the mix while pumping, affecting a homogeneous distribution of heat throughout the cementitious material extrusion. In certain embodiments, as described above, a motor 124 can be configured to drive the auger 103.

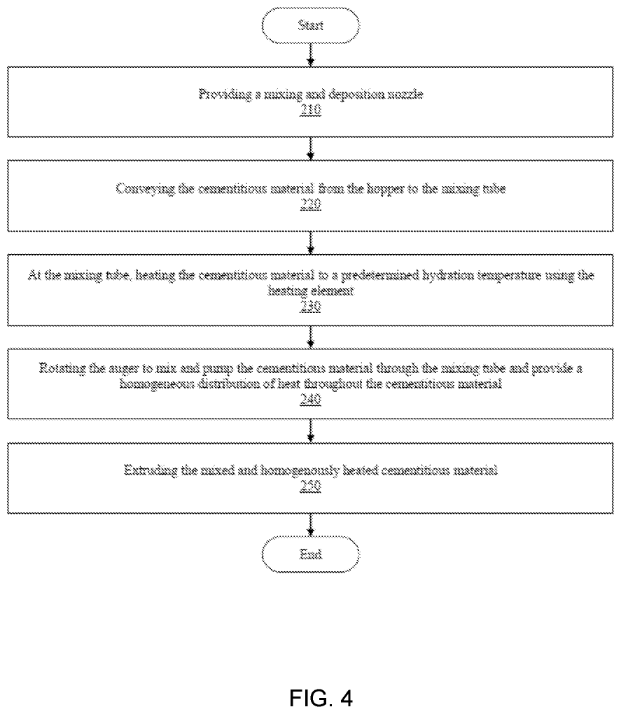

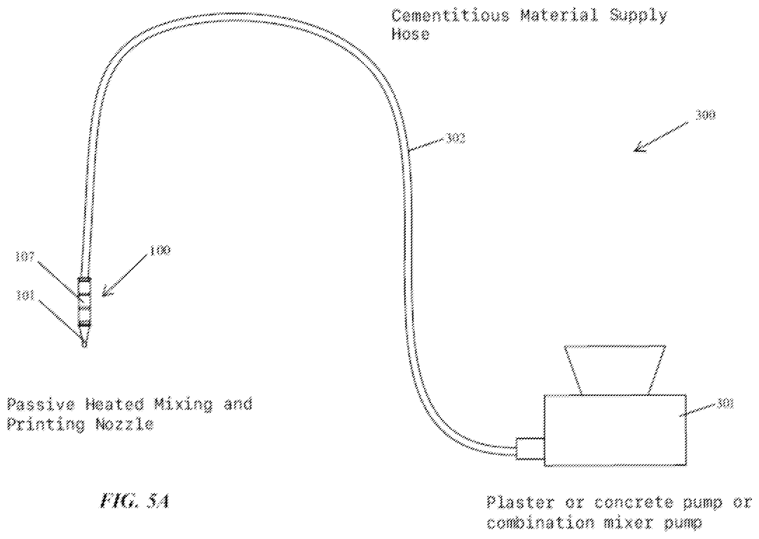

FIG. 4 is a flowchart showing an extrusion method for 3D printing a cementitious material. At step 210, the extrusion method can include providing a mixing and deposition nozzle 101. The mixing and deposition nozzle 101 can include a hopper 109 in communication with a mixing tube 105, where the mixing tube 105 is in communication with a deposition tip 102. A heating element 107 can be disposed on an outside surface 125 of the mixing tube 105. The heating element 107 can be configured to transfer heat to an interior portion 115 of the mixing tube 105. An auger 103 disposed within the mixing tube 105 can be configured to promote mixing and pumping of the cementitious material through the mixing tube 105 in order to provide a homogeneous distribution of heat throughout the cementitious material when the heating element 107 transfers heat to the interior portion 115 of the mixing tube 105.

At step 220, the extrusion method can include conveying the cementitious material from the hopper 109 to the mixing tube 105. At step 230, the cementitious material can be heated at the mixing tube 105 to a predetermined temperature to accelerate a chemical reaction process of the cementitious material using the heating element 107. Then, at step 240, the auger 103 can be rotated to mix and pump the cementitious material through the mixing tube 105 and provide a homogeneous distribution of heat throughout the cementitious material. At 250, the mixed and homogenously heated cementitious material can be extruded. In certain embodiments, a portion of the auger can be disposed within the hopper. In particular, conveying the cementitious material from the hopper to the mixing tube can be performed by the auger.

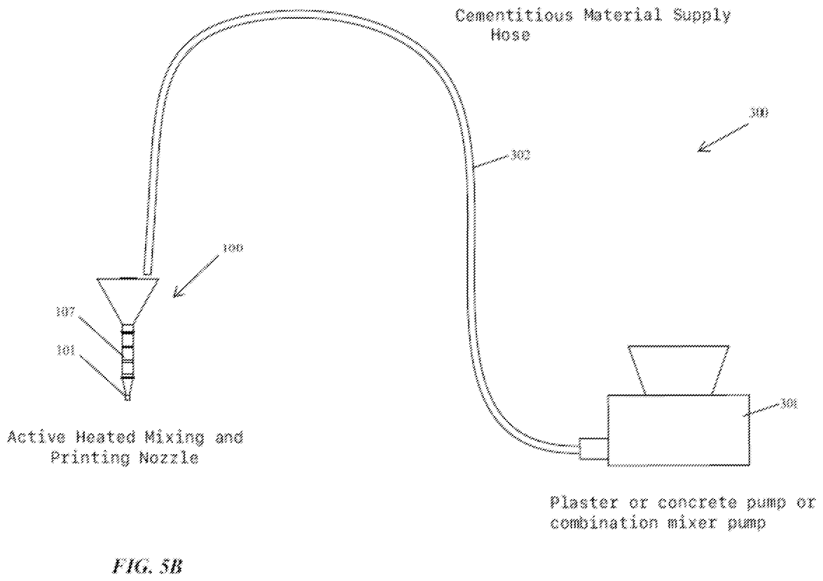

FIG. 5A shows a split module configuration 300 of a heated passive extruder 100 for 3D printing of a cementitious material, with a remote pumping device 301 placed upstream and a material supply hose 302 from such as a plaster or mixing pump and a passive mixing device fitted with heating elements 107 connected with the nozzle 101.

In this configuration, the cementitious material can be supplied to the heated passive extruder 100 by a material supply hose 302 from such as a plaster or mixing pump 301. As shown in FIG. 5A, the heated passive extruder 100 is passively mixing the heat into the cementitious material utilizing the drive of the remote pumping device 301 to supply the required pressure.

FIG. 5B shows the module configuration 303 of a heated active extruder 100 for 3D printing of a cementitious material supplied upstream from a plaster or mixing pump, through a supply hose 302, and an active mixing head fitted with heating elements 107 connected with the nozzle 101.

In this configuration, the cementitious material can be supplied to the heated active extruder 100 by the remote pumping device 301. As shown in FIG. 5B, the heated extruder 100 is actively mixing the heat into the cementitious material with its own auger and drive motor.

As would be apparent to someone of ordinary skill in the art, the heated extruder 100 can be mounted to and/or supported by any appropriately desired mechanism. For example, in certain embodiments the heated extruder 100 can be supported by a 6-axis extruder mount or arm. In other embodiments, the heated extruder 100 can be supported by a gantry.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A heated extruder for 3D printing of a cementitious material, comprising:
a mixing and deposition nozzle configured to extrude cementitious material;
a motor configured to provide the cementitious material to the mixing and deposition nozzle;
a heating element in communication with the mixing and deposition nozzle, the heating element configured to transfer heat to the cementitious material within an interior portion of the mixing and deposition nozzle; and
at least one sensor configured to generate temperature readings for the cementitious material; and
a controller configured to receive the temperature readings, and control the motor and the heating element so as to ensure that the hardening process of the cementitious material is optimum.

2. The heated extruder for 3D printing of a cementitious material of claim 1, wherein the at least one sensor comprises an external sensor configured to measure a temperature of the cementitious material during or after deposition.

3. The heated extruder for 3D printing of a cementitious material of claim 1, wherein the at least one sensor comprises a thermal camera, a thermocouple, or both.

4. The heated extruder for 3D printing of a cementitious material of claim 1, wherein the cementitious material sensor comprises a sensor located along a length of the mixing and deposition nozzle.

5. The heated extruder for 3D printing of a cementitious material of claim 1, wherein the heating element is disposed around an entirety of the outside surface of a mixing tube included in the mixing and deposition nozzle.

6. The heated extruder for 3D printing of a cementitious material of claim 1, wherein the heating element includes a plurality of external band heaters.

7. The heated extruder for 3D printing of a cementitious material of claim 1, wherein the controller comprises a proportional, integral, derivative (PID) controller.

8. The heated extruder for 3D printing of a cementitious material of claim 1, wherein the controller is configured to control the heating element to heat the cementitious material to a temperature from 50° F. to 150° F.

9. The heated extruder for 3D printing of a cementitious material of claim 1, further comprising an auger including a flight having a perforation, the auger disposed within a mixing tube of the mixing and deposition nozzle, the auger configured to promote mixing and pumping of the cementitious material through the mixing tube, and providing a homogeneous distribution of heat throughout the cementitious material when the heating element transfers heat to the cementitious material.

10. The heated extruder for 3D printing of a cementitious material of claim 1, wherein a material conveying function and a heating function are split between multiple modules consisting in a remote pumping device placed upstream, and a passive or active mixing.
